(19) United States
(12) Patent Application Publication
(10) Pub. No.: US 2022/0263186 A1
(43) Pub. Date: Aug. 18, 2022

(54) CUSHIONING SHEET AND METHOD FOR MANUFACTURING SAME

(71) Applicant: Sumitomo Riko Company Limited, Aichi (JP)

(72) Inventors: Keiji MAKINO, Aichi (JP); Eiji Tanaka, Aichi (JP)

(73) Assignee: Sumitomo Riko Company Limited, Aichi (JP)

(21) Appl. No.: 17/737,025

(22) Filed: May 5, 2022

Related U.S. Application Data
(63) Continuation of application No. PCT/JP2021/012897, filed on Mar. 26, 2021.

(30) Foreign Application Priority Data
Jun. 30, 2020 (JP) 2020-112903

(51) Int. Cl. H01M 50/291; H01M 50/209; H01M 10/0525; B29C 48/08

(52) U.S. Cl. CPC H01M 50/291; H01M 50/209; B29L 2007/002; B29C 48/08; H01M 10/0525

(57) ABSTRACT

A cushioning sheet includes: main support parts extending in a reference direction and arranged with at least a part of a wide surface in contact with a first member and a narrow surface facing the wide surface back-to-back in contact with a second member; and a band-shaped connection part connecting the adjacent main support parts and arranged in contact with the first member and at a distance from the second member. A main recess extending in the reference direction and opening toward the first member is formed in a central part of the wide surface of the main support part in a width direction. A sub-recess extending in the reference direction, opening toward at least one of the first member and the second member, and having an opening width smaller than the main recess is formed in a boundary portion between the main support parts and the connection part.

### CROSS-REFERENCE TO RELATED APPLICATION

This application is a continuation of PCT International Application No. PCT/JP2021/012897, filed on Mar. 26, 2021, which claims priority under 35 U.S.C. § 119(a) to Japanese Patent Application No. 2020-112903, filed on Jun. 30, 2020. Each of the above application(s) is hereby expressly incorporated by reference, in its entirety, into the present application.

### BACKGROUND

### Technical Field

The disclosure relates to a cushioning sheet and a method for manufacturing the same.

### Related Art

For example, Patent Literatures 1 to 3 describe a battery module in which a plurality of battery cells are laminated and a cushioning sheet absorbing the deformation of the battery cells is disposed between the battery cells. The cushioning sheet (referred to as a spacer) described in Patent Literature 3 includes a convex part which contacts the battery cell and a recess (referred to as a space part) is formed on the rear surface side of the convex part. Since the convex part has the recess on the rear surface side, the convex part is elastically deformable in the thickness direction when the battery cell is expanded and deformed.
Patent Literature 1: Japanese Patent Laid-Open No. 2012-59380
Patent Literature 2: Japanese Patent Laid-Open No. 2018-81790
Patent Literature 3: Japanese Patent Laid-Open No. 2019-128991

When a separation distance between two battery cells sandwiching the cushioning sheet is reduced in accordance with the expanding deformation of the battery cell, the compressive deformation amount of the convex part of the cushioning sheet increases. The volume of the recess on the rear surface side of the convex part becomes small in accordance with the compression deformation of the convex part. In this way, it is possible to absorb the elastic deformation corresponding to the volume of the recess. However, when the recess is in a filled state, the support force by the convex part sharply increases.

Therefore, in order to further increase the deformation amount of the cushioning sheet in the thickness direction, the recess on the rear surface side of the convex part is enlarged. However, in order to ensure the rigidity of the convex part (the support force by the convex part), it is not easy to enlarge the recess.

### SUMMARY

According to an aspect of the disclosure, provided is a cushioning sheet formed of an elastic material and sandwiched between a first member and a second member facing each other, the cushioning sheet including: a plurality of main support parts, extending in a predetermined reference direction in a plane direction of the cushioning sheet, formed in a tapered shape having a wide surface and a narrow surface facing back-to-back in a cross-section orthogonal to the reference direction, and disposed with at least a part of the wide surface in contact with the first member and the narrow surface in contact with the second member; and a connection part having a band shape, connecting inclined side surfaces of the tapered shape on the wide surface side in adjacent ones of the main support parts, and disposed in contact with the first member and at a distance from the second member. In a central part of the tapered shape in a width direction in the wide surface of the main support part, a main recess is formed extending in the reference direction and opening toward the first member. In a boundary portion between the main support part and the connection part, a sub-recess is formed extending in the reference direction, opening toward at least one of the first member and the second member, and having a smaller opening width than the main recess.

According to another aspect of the disclosure, provided is a method for manufacturing a cushioning sheet, the method manufacturing the above-described cushioning sheet and including: extrusion-molding an elastic material whose base material is resin or elastomer by an extruder in which an extrusion direction matches the reference direction and a cross-section orthogonal to the extrusion direction has a C shape or a U shape; and widening with the main recess and the sub-recess as a starting point so that a slit having the C shape or the U shape that is extrusion-molded is located at both ends.

### BRIEF DESCRIPTION OF DRAWINGS

FIG. 1 is a diagram showing a battery module which adopts a cushioning sheet in a non-expansion state of a battery cell.

FIG. 2 shows a maximum expansion state when the battery cell is fully charged in the battery module shown in FIG. 1.

FIG. 3 is a perspective view of a cushioning sheet of a first example.

FIG. 4 is an enlarged front view of the cushioning sheet of the first example in a reference state (non-deformation state).

FIG. 5 is an enlarged front view of the cushioning sheet of the first example in a deformation state.

FIG. 6 is an enlarged front view of a cushioning sheet of a second example in a reference state (non-deformation state).

FIG. 7 is an enlarged front view of the cushioning sheet of the second example in a deformation state.

FIG. 8 is an enlarged front view of a cushioning sheet of a third example in a reference state (non-deformation state).

FIG. 9 is an enlarged front view of a cushioning sheet of a fourth example in a reference state (non-deformation state).

FIG. 10 is an enlarged front view of a cushioning sheet of a fifth example in a reference state (non-deformation state).

FIG. 11 is a perspective view of a cushioning sheet of a sixth example.

FIG. 12 is a perspective view of a cushioning sheet of a seventh example.

FIG. 13 is a flowchart showing a manufacturing method of the cushioning sheet.

FIG. 14 is a perspective view showing the cushioning sheet subjected to extrusion-molding.

FIG. 15 is an enlarged front view of the cushioning sheet subjected to extrusion-molding.

### DESCRIPTION OF EMBODIMENTS

The disclosure provides a cushioning sheet capable of increasing a deformation amount of the cushioning sheet in a thickness direction while sufficiently having a support force by the cushioning sheet and a method for manufacturing the same.

According to an aspect of the disclosure, provided is a cushioning sheet formed of an elastic material and sandwiched between a first member and a second member facing each other, the cushioning sheet including: a plurality of main support parts, extending in a predetermined reference direction in a plane direction of the cushioning sheet, formed in a tapered shape having a wide surface and a narrow surface facing back-to-back in a cross-section orthogonal to the reference direction, and disposed with at least a part of the wide surface in contact with the first member and the narrow surface in contact with the second member; and a connection part having a band shape, connecting inclined side surfaces of the tapered shape on the wide surface side in adjacent ones of the main support parts, and disposed in contact with the first member and at a distance from the second member. In a central part of the tapered shape in a width direction in the wide surface of the main support part, a main recess is formed extending in the reference direction and opening toward the first member. In a boundary portion between the main support part and the connection part, a sub-recess is formed extending in the reference direction, opening toward at least one of the first member and the second member, and having a smaller opening width than the main recess.

According to another aspect of the disclosure, provided is a method for manufacturing a cushioning sheet, the method manufacturing the above-described cushioning sheet and including: extrusion-molding an elastic material whose base material is resin or elastomer by an extruder in which an extrusion direction matches the reference direction and a cross-section orthogonal to the extrusion direction has a C shape or a U shape; and widening with the main recess and the sub-recess as a starting point so that a slit having the C shape or the U shape that is extrusion-molded is located at both ends.

According to the above-described cushioning sheet, the main recess is formed on the wide surface side of the main support part. Thus, when the separation distance between the first member and the second member is reduced, the main support part is deformed in the height direction so that the volume of the main recess decreases. In this way, the main recess functions as a region that absorbs the deformation of the main support part.

Further, the sub-recess is formed in the boundary portion between the main support part and the connection part. Thus, when the separation distance between the first member and the second member is reduced, the sub-recess functions as a region that absorbs the deformation of the main support part in addition to the main recess.

Further, since the main recess is formed on the wide surface side of the main support part, the main support part tends to be deformed to expand the width of the wide surface when the separation distance between the first member and the second member is reduced. As a result, the connection part receives a compressive load from the adjacent main support part in the band width direction of the connection part. At this time, the connection part tends to buckle in the band width direction from the sub-recess. That is, the connection part is curved and deformed in a convex shape toward the second member from the sub-recess in accordance with the expansion of the wide surface of the main support part. Due to the curving and deformation of the connection part, the main support part can be further deformed in the plane direction and hence the deformation amount in the height direction of the main support part can be increased.

Since the main recess and the sub-recess are formed in this way, the adjacent space of the main recess, the sub-recess, and the inclined side surface of the main support part functions as a region that absorbs the deformation of the main support part. As a result, it is possible to increase the deformation amount of the main support part in the height direction. Further, since it is not a structure in which only the main recess functions as a region that absorbs the deformation of the main support part, it is possible to ensure the rigidity of the inclined leg parts on both sides of the main support part in the width direction and thus to sufficiently ensure the support force by the main support part.

If the cushioning sheet having a flat plate shape is extrusion-molded by an extruder, the maximum width of the mold of the extruder needs to be the width or more of the cushioning sheet. Thus, when the width of the cushioning sheet increases, the mold of the extruder increases in size. However, as described above, according to the cushioning sheet manufacturing method, the cushioning sheet is manufactured by extrusion-molding a cross-section orthogonal to the extrusion direction into a C shape or a U shape by the extruder and widening the cross-section so that C-shaped or U-shaped slits are located at both ends. Thus, the mold of the extruder can be made smaller than the width of the cushioning sheet.

Further, when widening the premolded product having a C-shaped or U-shaped cross-section subjected to extrusion-molding, the main recess and the sub-recess are used as starting points. Thus, the cushioning sheet can be formed in a desired shape even after the cushioning sheet is extrusion-molded into a C shape or a U shape by an extruder and then is widened.

(1. Application Target of Cushioning Sheet)

A cushioning sheet is sandwiched between a first member and a second member facing each other and has a function of relaxing a load applied to the first member and the second member when the first member and the second member come close to each other. In particular, the cushioning sheet exhibits a cushioning function when the first member and the second member come close to each other from a reference state when the contact state of the first member and the second member is the reference state. The first member and the second member may be any member as long as they are targets for relaxing the received load. For example, the first member and the second member can be housings formed of metal, resin, or the like.

(2. Example of Application Target of Cushioning Sheet)

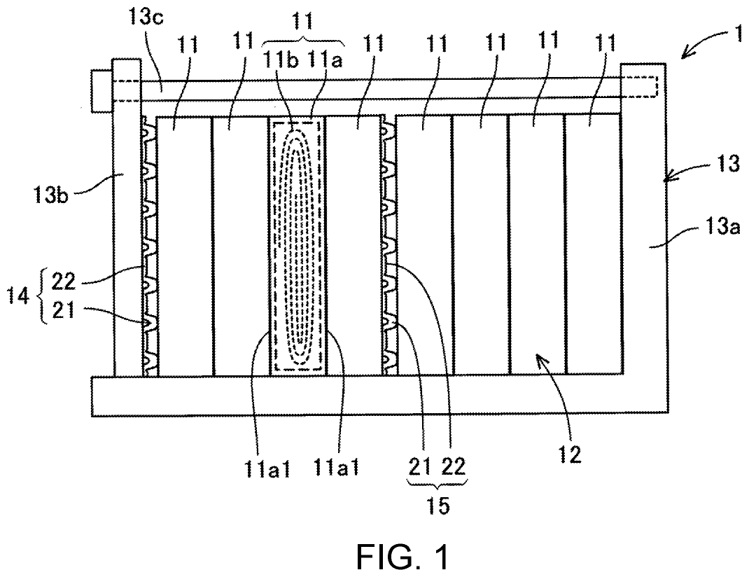

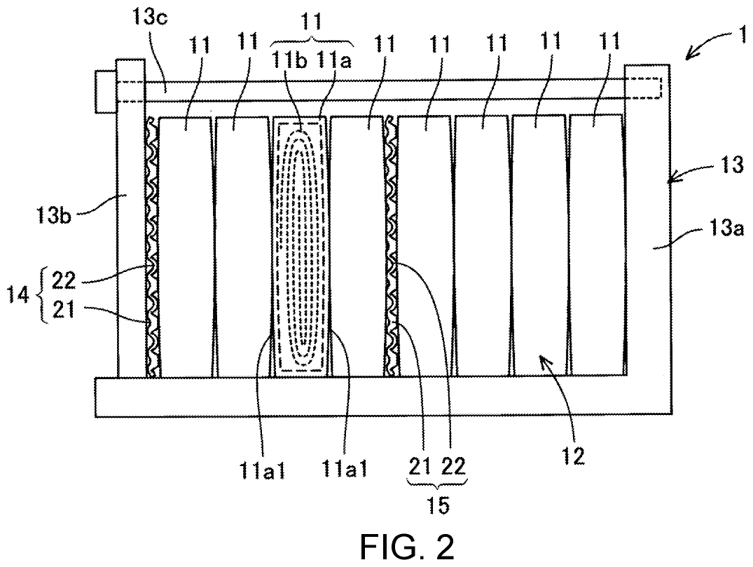

A battery module 1 is given as an example of the application target of the cushioning sheet. The battery module 1 will be described with reference to FIGS. 1 and 2. Examples of the battery module 1 include a storage battery such as a lithium ion secondary battery in an automobile or a household and a cell stack of a fuel cell system.

The battery module 1 includes a laminated body 12 obtained by laminating a plurality of battery cells 11, a restraining member 13, a first cushioning sheet 14, and a second cushioning sheet 15. However, the battery module 1 includes both the first cushioning sheet 14 and the second cushioning sheet 15 as an example, but may include any one of the first cushioning sheet 14 and the second cushioning sheet 15.

Each of the battery cells 11 constituting the laminated body 12 is formed in, for example, a flat rectangular parallelepiped shape. In the laminated body 12, the flat battery cells 11 are laminated in a direction orthogonal to the flat plane direction (flat normal direction).

The battery cell 11 includes a housing 11a which is formed in a flat rectangular parallelepiped box shape and an electrode body 11b which is wound inside the housing 11a. The housing 11a is formed of, for example, a metal such as aluminum and a hard resin. Hereinafter, a surface orthogonal to the flat plane direction in the housing 11a is referred to as a target surface 11a1. The electrode body 11b includes a positive electrode, a negative electrode, and a separator sandwiched between the positive electrode and the negative electrode and is wound in a flat shape.

As shown in FIG. 2, the electrode body 11b is not expanded mainly in the flat normal direction by generating heat with charging. The expansion amount of the electrode body 11b decreases with discharging. Thus, the housing 11a of the battery cell 11 accommodating the electrode body 11b is expanded in the flat normal direction during charging. In particular, since the housing 11a is formed in a flat rectangular parallelepiped box shape, the target surface 11a1 is likely to be expanded and deformed in a curved convex shape. When the battery cell 11 is fully charged, the expansion amount of the target surface 11a1 of the housing 11a becomes maximum. When the battery cell 11 is discharged, the target surface 11a1 of the housing 11a ideally returns to a planar shape as the expansion amount of the electrode body 11b decreases. However, the target surface does not gradually return to the original shape due to the deterioration of the electrode body 11b and the battery performance deteriorates.

The restraining member 13 restrains the laminated body 12 from both ends of the laminated body 12 in the lamination direction. That is, the restraining member 13 acts to return the battery cell 11 to a reference state (non-expansion state) by applying a reaction force to each battery cell 11 when each battery cell 11 is expanded by charging.

The restraining member 13 includes, for example, a first restraining member 13a, a second restraining member 13b, and a connection member 13c. The first restraining member 13a is formed in an L shape and is disposed on a seat portion on which the laminated body 12 is placed and a portion (end restraining portion) which supports a first end (the right side of FIG. 1) of the laminated body 12 in the lamination direction. Specifically, the end restraining portion of the first restraining member 13a is disposed to face the target surface 11a1 of the battery cell 11 located at the first end of the laminated body 12 in the lamination direction. Further, a surface facing the battery cell 11 in the end restraining portion of the first restraining member 13a is formed in a planar shape.

The second restraining member 13b is formed in a flat plate shape and is disposed on a second end side (the left side of FIG. 1) opposite to the first end of the laminated body 12 in the lamination direction. Specifically, the second restraining member 13b is disposed to face the target surface 11a1 of the battery cell 11 located at the second end of the laminated body 12 in the lamination direction. Further, a surface facing the battery cell 11 in the second restraining member 13b is formed in a planar shape.

Thus, the laminated body 12 is sandwiched in the lamination direction by the end restraining portion of the first restraining member 13a and the second restraining member 13b. The connection member 13c connects the end restraining portion of the first restraining member 13a to the second restraining member 13b. Metal is preferably used to exhibit a sufficient restraining force in each of the members 13a, 13b, and 13c constituting the restraining member 13, but hard resin can also be used.

The first cushioning sheet 14 is sandwiched between the second restraining member 13b and the target surface 11a1 of the battery cell 11 located at the second end of the laminated body 12 in the lamination direction. That is, the first cushioning sheet 14 is sandwiched between the battery cell 11 which is one member of the first member and the second member and the second restraining member 13b which is the other member of the first member and the second member.

The first cushioning sheet 14 is formed of an elastic material to absorb deformation due to an increase or decrease in the expansion amount of the battery cell 11. Then, as shown in FIG. 1, the first cushioning sheet 14 contacts the target surface 11a1 of the battery cell 11 and the second restraining member 13b to elastically support the battery cell 11 in the reference state in which the battery cell 11 is not expanded. Further, as shown in FIG. 2, the first cushioning sheet 14 elastically supports the battery 11 in the expansion state according to the charging of the battery cell 11 and applies a pressing force to the battery cell 11 when the expansion amount decreases according to the discharging of the battery cell 11.

The second cushioning sheet 15 is sandwiched between the target surfaces 11a1 and 11a1 of the battery cells 11 and 11 which are adjacent to each other in the lamination direction. That is, the second cushioning sheet 15 is sandwiched between one adjacent battery cell 11 which is the first member and the other adjacent battery cell 11 which is the second member.

Similarly to the first cushioning sheet 14, the second cushioning sheet 15 is formed of an elastic material and absorbs deformation in accordance with an increase or decrease in the expansion amount of the battery cell 11. Then, as shown in FIG. 1, the second cushioning sheet 15 contacts the target surfaces 11a1 and 11a1 of the facing battery cells 11 and 11 to elastically support the battery cell 11 in the reference state in which the battery cell 11 is not expanded. Further, as shown in FIG. 2, the second cushioning sheet 15 elastically supports the battery cell 11 in the expansion state according to the charging of the battery cell 11 and applies a pressing force to the battery cell 11 when the expansion amount decreases according to the discharging of the battery cell 11.

Then, as the number of the battery cells 11 constituting the laminated body 12 increases, a change in the total length of the laminated body 12 as the expansion amount of the battery cells 11 increases or decreases becomes larger. Thus, the first cushioning sheet 14 and the second cushioning sheet 15 preferably exhibit the above functions in order to reliably absorb a change in the total length of the laminated body 12.

In this example, the first cushioning sheet 14 and the second cushioning sheet 15 have the same configuration. However, the first cushioning sheet 14 and the second cushioning sheet 15 may have different configurations.

The first cushioning sheet 14 and the second cushioning sheet 15 include a plurality of main support parts 21 which contact and elastically support the first member and the second member facing the cushioning sheets at all times and connection parts 22 which connect the adjacent main support parts to each other. As shown in FIGS. 1 and 2, the main support part 21 is mainly compressed and deformed in accordance with the expansion of the battery cell 11. Then, the connection part 22 is curved and deformed in accordance with the compression deformation of the main support part 21.

(3. Example of Cushioning Sheet)

Specific examples of the cushioning sheets 14 and 15 will be described. Hereinafter, cushioning sheets 30, 40, 50, 60, 70, 80, and 90 of first to seventh examples will be described.

(3-1. Cushioning Sheet 30 of First Example)

(3-1-1. Configuration of Cushioning Sheet 30)

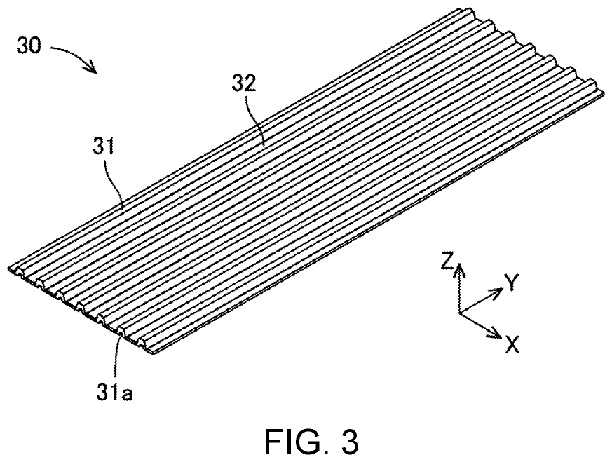

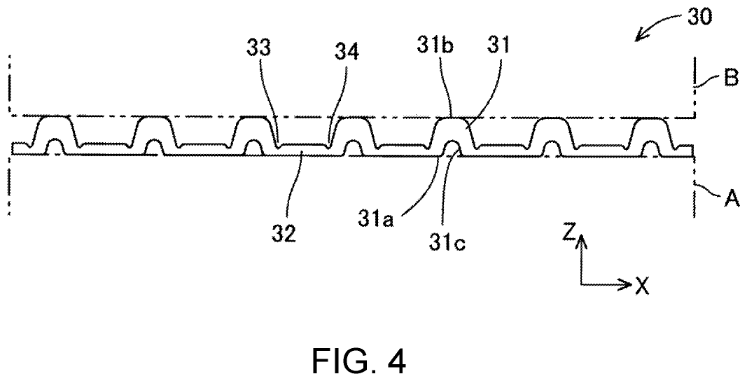

A configuration of a cushioning sheet 30 of a first example will be described with reference to FIGS. 3 and 4. As shown in FIG. 3, the cushioning sheet 30 is formed in a shape (planar shape) extending in the plane direction parallel to the X-Y plane. The cushioning sheet 30 is formed of an elastic material. For example, the cushioning sheet 30 is formed of an elastic material whose base material is resin or elastomer. For the cushioning sheet 30, for example, an elastomer excellent in a low temperature environment such as EPDM is preferably used.

The cushioning sheet 30 may be entirely formed of the same type of elastic material or may be formed of a plurality of types of elastic materials. In the latter case, for example, in the plane thickness direction (Z direction) of the cushioning sheet 30, a different elastic material may be applied to the front surface layer, the back surface layer, and the intermediate layer. Alternatively, the same elastic material may be applied to the front surface layer and the back surface layer and a different elastic material may be applied to the intermediate layer.

The cushioning sheet 30 includes a plurality of main support parts 31 (corresponding to the main support parts 21 of FIGS. 1 and 2) and a plurality of connection parts 32 (corresponding to the connection parts 22 of FIGS. 1 and 2).

The main support part 31 extends in a predetermined reference direction (Y direction) in the plane direction of the X-Y plane of the cushioning sheet 30. That is, each main support part 31 is formed of an elongated body extending in the Y direction. Particularly, in this example, as shown in FIG. 3, each main support part 31 is formed of one elongated body extending over the entire length in the reference direction (Y direction) of the cushioning sheet 30. Further, the plurality of main support parts 31 is arranged in parallel at equal intervals in the X direction.

As shown in FIG. 4, the main support part 31 is formed in a tapered shape in a cross-section orthogonal to the reference direction (Y direction) (a cross-section parallel to the X-Z plane). Examples of the tapered shape include a trapezoid, a chevron with a curved tip, and the like. In this example, the main support part 31 is formed in an isosceles trapezoid, but may be an isosceles trapezoid.

The main support part 31 is formed in a tapered shape with a wide surface 31a and a narrow surface 31b facing back-to-back. A base end surface of the tapered shape is the wide surface 31a and a tip surface thereof is the narrow surface 31b. In this example, the wide surface 31a and the narrow surface 31b are surfaces which are parallel to the X-Y plane. That is, the wide surface 31a and the narrow surface 31b are surfaces which are parallel to the plane direction of the cushioning sheet 30.

Additionally, the narrow surface 31b may be a curved surface in which a cross-section orthogonal to the reference direction (Y direction) (a cross-section parallel to the X-Z plane) protrudes in the Z direction. Also in this configuration, the wide surface 31a and the narrow surface 31b are surfaces parallel to the plane direction of the cushioning sheet 30.

Further, a main recess 31c which extends in the reference direction (Y direction) is formed at the central part of the wide surface 31a of the main support part 31 in the width direction (X direction). The main recess 31c is formed over the entire length of the main support part 31. The width of the main recess 31c is the largest at the opening part and becomes smaller toward the bottom part. That is, the width of the main recess 31c gradually becomes narrow in the depth direction.

As shown in FIG. 4, at least a part of the wide surface 31a of the main support part 31 contacts the first member A (in FIG. 1, the battery cell 11 or the second restraining member 13b). In this example, the wide surface 31a is provided with the main recess 31c. Then, the main recess 31c opens toward the first member A. Thus, a portion excluding the portion in which the main recess 31c opens in the wide surface 31a of the main support part 31 contacts the first member A.

Further, the narrow surface 31b of the main support part 31 contacts the second member B. Here, the narrow surface 31b is not provided with a recess. Thus, the entire surface of the narrow surface 31b in the width direction contacts the second member B.

In this way, when the first member A and the second member B are in the reference state (farthest state), the main support part 31 is disposed so that the wide surface 31a contacts the first member A and the narrow surface 31b contacts the second member B. As shown in FIG. 1, when the application target of the cushioning sheet 30 is the battery module 1, the wide surface 31a contacts one member of the battery cell 11 and the second restraining member 13b and the narrow surface 31b contacts the other member in the reference state in which the battery cell 11 is not expanded.

The connection part 32 is formed in a band shape and connects the adjacent main support parts 31 and 31. Both ends of the connection part 32 in the band width direction are connected to the adjacent main support parts 31 and 31. The connection part 32 is formed in a flat shape parallel to the X-Y plane. That is, the connection part 32 is formed in a planar shape on both flat surfaces in the non-deformation state. The band width of the connection part 32 is formed to be, for example, substantially the same as the width of the wide surface 31a of the main support part 31.

The thickness of the connection part 32 (the thickness in the Z direction) is sufficiently smaller than the height of the main support part 31 (the height in the Z direction). Then, the connection part 32 connects inclined side surfaces (for example, trapezoidal leg surfaces) of the tapered shape on the wide surface 31a side in the adjacent main support parts 31 and 31. More specifically, one surface of the connection part 32 (a surface on the first member A side) is located on the same surface as the wide surface 31a of the main support part 31. On the other hand, the other surface of the connection part 32 (a surface on the second member B side) is located on the first member A side in relation to the narrow surface 31b of the main support part 31. That is, the main support part 31 and the connection part 32 have a positional relationship such that the main support part 31 protrudes from the connection part 32 toward the second member B.

That is, when the first member A and the second member are in the reference state (farthest state), the connection part 32 is disposed so that one surface contacts the first member A and the other surface has a distance from the second member B.

Here, the connection part 32 is formed in a shape allowing the deformation. The connection part 32 can be deformed so that the distance between both ends in the band width direction is reduced. For example, the connection part 32 buckles in the band width direction and is curved and deformed.

Sub-recesses 33 and 34 are formed in the boundary portion between the main support part 31 and the connection part 32. In this example, the sub-recesses 33 and 34 are formed in the boundary portion between the surface on the second member B side of the connection part 32 and the inclined side surface of the main support part 31. That is, the sub-recesses 33 and 34 open toward the second member B. The sub-recesses 33 and 34 extend in the reference direction (Y direction). In this example, the sub-recesses 33 and 34 are formed over the entire length of the main support part 31. Further, the opening width of the sub-recesses 33 and 34 is smaller than the opening width of the main recess 31c. Further, the depth from the openings of the sub-recesses 33 and 34 is shallower than the depth from the opening of the main recess 31c.

(3-1-2. Action of Cushioning Sheet 30)

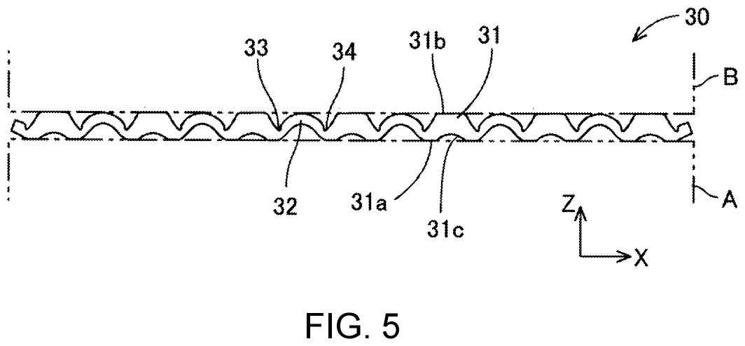

Next, the action of the cushioning sheet 30 of the first example will be described with reference to FIGS. 4 and 5. When the separation distance between the first member A and the second member B is reduced, the cushioning sheet 30 is deformed as shown in FIG. 5. Here, FIG. 5 shows a case in which the separation distance between the first member A and the second member B is reduced while both members are parallel to each other. However, the separation distance between the first member A and the second member B is not limited to that case.

When the separation distance between the first member A and the second member B is reduced, the main support part 31 is compressed and deformed. In particular, since the main support part 31 includes the main recess 31c which opens toward the first member A, both inclined leg parts of the main support part 31 in the width direction are compressed and deformed. That is, the main support part 31 is deformed in the height direction (Z direction) to reduce the volume of the main recess 31c. In this way, the main recess 31c functions as a region that absorbs the deformation of the main support part 31.

Further, the sub-recesses 33 and 34 are formed in the boundary portion between the main support part 31 and the connection part 32. Thus, when the separation distance between the first member A and the second member B is reduced, the sub-recesses 33 and 34 function as a region that absorbs the deformation of the main support part 31 in addition to the main recess 31c.

Further, the cross-section of the main support part 31 has a tapered shape (for example, a trapezoid) and the main recess 31c is formed on the wide surface 31a side. Further, the connection part 32 is allowed to buckle in the band width direction. Therefore, when the separation distance between the first member A and the second member B is reduced, the main support part 31 is deformed so that the width (X-direction width) of the wide surface 31a is widened in the width direction. That is, the main support part 31 is deformed so that the height is lowered and the width of the wide surface 31a is widened in the cross-section parallel to the X-Z plane. Thus, the adjacent space of the inclined side surface (for example, the trapezoidal leg surface) of the main support part 31 functions as a region that absorbs the deformation of the main support part 31.

As described above, the adjacent space of the main recess 31c, the sub-recesses 33 and 34, and the inclined side surface (for example, the trapezoidal leg surface) of the main support part 31 functions as a region that absorbs the deformation of the main support part 31. As a result, it is possible to increase the deformation amount of the main support part 31 in the height direction. That is, it is possible to shorten the separation distance between the first member A and the second member B. Here, the main recess 31c does not become too large compared to a case in which only the main recess 31c functions as a region that absorbs the deformation of the main support part 31. That is, since it is not a structure in which only the main recess 31c functions as a region that absorbs the deformation of the main support part 31, it is possible to ensure the rigidity of the inclined leg parts on both sides of the main support part 31 in the width direction and thus to sufficiently ensure the support force by the main support part 31.

As described above, since the main recess 31c is formed on the wide surface 31a side of the main support part 31, the main support part 31 tries to be deformed so that the width of the wide surface 31a is widened when the separation distance between the first member A and the second member B is reduced. As a result, the connection part 32 receives a compressive load in the band width direction (X direction) of the connection part 32 from the adjacent main support part 31.

At this time, the connection part 32 is likely to buckle in the band width direction from the sub-recesses 33 and 34. That is, as shown in FIG. 5, the connection part 32 is curved and deformed in a convex shape toward the second member B from the sub-recesses 33 and 34 as the wide surface 31a of the main support part 31 is expanded. More specifically, the connection part 32 is curved and deformed in a convex shape toward the second member B when the deformation for changing the opening width of the sub-recesses 33 and 34 starts.

More specifically, as the main support part 31 is deformed, the cross-section in the band width direction (X direction) of the connection part 32 is curved and deformed in a convex shape toward the second member B with the sub-recesses 33 and 34 as a starting point. That is, since the sub-recesses 33 and 34 are formed on the buckling side of the connection part 32, the sub-recesses 33 and 34 are effectively used as the start points of the deformation of the connection part 32. Then, the main support part 31 can be further deformed in the plane direction (X direction) due to the curving and deformation of the connection part 32 and hence the deformation amount of the main support part 31 in the height direction can be increased.

A surface on the first member A side in the connection part 32 is deformed in a curved concave shape and forms a space with the first member A. On the other hand, a surface on the second member B side in the connection part 32 is deformed in a curved convex shape and approaches the second member B. In a state in which the connection part 32 is curved and deformed in a convex shape, a surface on the second member B side in the connection part 32 may be brought into contact with the second member B or may not be brought into contact with the second member B. When the connection part 32 is brought into contact with the second member B, the connection part 32 presses the second member B. That is, the connection part 32 exhibits a support force. In this way, it is possible to freely design the characteristic of the support force of the cushioning sheet 30 by using the support force of the connection part 32.

Here, for example, in the battery module 1 shown in FIG. 1, the cushioning sheet 30 can be designed on the basis of the maximum expansion amount when the battery cell 11 is fully charged. When the battery cell 11 is fully charged, a surface on the second member B side in the connection part 32 may contact the second member B or may not contact the second member B. Further, when the battery cell 11 is fully charged, area of a space formed by the connection part 32 in a curved and deformation state and the first member A may be designed to be greater than the area of the main recess 31c in the cross-section parallel to the X-Z direction.

(3-2. Cushioning Sheet 40 of Second Example)

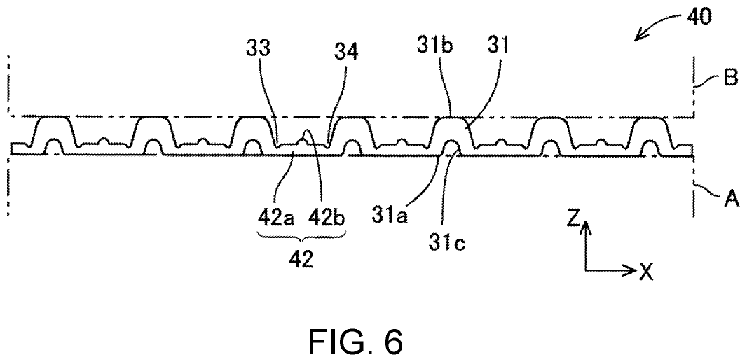

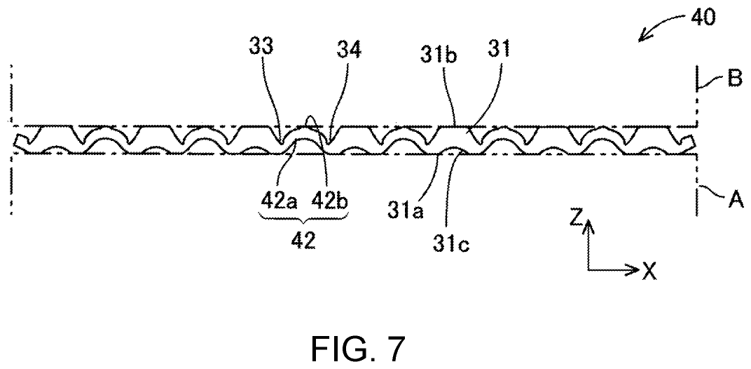

A cushioning sheet 40 of a second example will be described with reference to FIGS. 6 and 7. In the cushioning sheet 40 of the second example, the same components as those of the cushioning sheet 30 of the first example are designated by the same reference numerals and the description thereof will be omitted.

As shown in FIG. 6, the cushioning sheet 40 includes a plurality of main support parts 31 and a plurality of connection parts 42. The main support part 31 has the same configuration as that of the main support part 31 of the first example. The connection part 42 includes a connection part body 42a and a small protrusion 42b. The connection part body 42a has the same configuration as that of the connection part 32 of the first example. The small protrusion 42b is formed on the surface on the second member B side in the connection part body 42a and has a protrusion height smaller than the protrusion height of the main support part 31. The small protrusion 42b is formed at the central part of the connection part body 42a in the band width direction.

When the separation distance between the first member A and the second member B is reduced, the main support part 31 is deformed as shown in FIG. 7. The connection part body 42a is curved and deformed in accordance with the deformation of the main support part 31. At this time, a surface on the second member B side in the connection part body 42a is curved and deformed to have a convex shape. When the deformation amount of the connection part body 42a becomes large, the small protrusion 42b contacts the second member B to be compressed and deformed. That is, since the small protrusion 42b is compressed and deformed, it is possible to freely design the characteristic of the support force of the cushioning sheet 40.

(3-3. Cushioning Sheet 50 of Third Example)

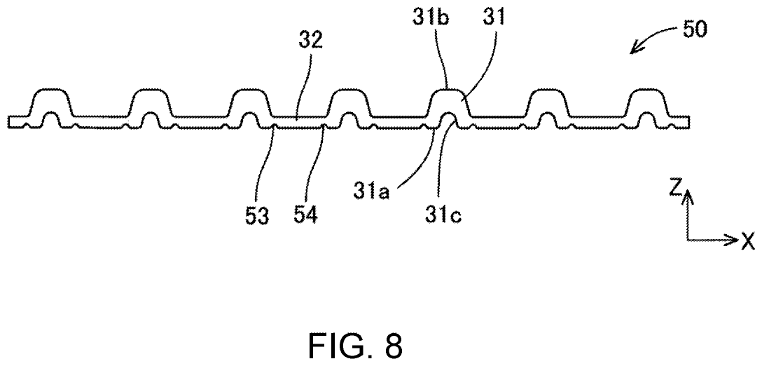

A cushioning sheet 50 of a third example will be described with reference to FIG. 8. In the cushioning sheet 50 of the third example, the same components as those of the cushioning sheet 30 of the first example are designated by the same reference numerals and the description thereof will be omitted. As shown in FIG. 8, the cushioning sheet 50 includes a plurality of main support parts 31 and a plurality of connection parts 32. The main support part 31 and the connection part 32 have the same configuration as the main support part 31 and the connection part 32 of the first example.

In the cushioning sheet 50, sub-recesses 53 and 54 are formed in the boundary portion between the main support part 31 and the connection part 32. In this example, the sub-recesses 53 and 54 are formed in the boundary portion between the surface on the first member A side in the connection part 32 and a wide surface 31a of the main support part 31. That is, the sub-recesses 53 and 54 open toward the first member A. The sub-recesses 53 and 54 extend in the reference direction (the Y direction). In this example, the sub-recesses 53 and 54 are formed over the entire length of the main support part 31. Further, the opening width of the sub-recesses 53 and 54 is smaller than the opening width of the main recess 31c. Further, the depth from the openings of the sub-recesses 53 and 54 is shallower than the depth from the opening of the main recess 31c.

When the separation distance between the first member A and the second member B is reduced, the main support part 31 tries to be deformed so that the width of the wide surface 31a is widened. As a result, the connection part 32 receives a compressive load from the adjacent main support part 31 in the band width direction (X direction) of the connection part 32.

At this time, the connection part 32 is likely to buckle in the band width direction from the sub-recesses 53 and 54. That is, as shown in FIG. 8, the connection part 32 is curved and deformed in a convex shape toward the second member B from the sub-recesses 53 and 54 as the wide surface 31a of the main support part 31 is widened. More specifically, the connection part 32 is curved and deformed in a convex shape toward the second member B with deformation in which the opening width of the sub-recesses 53 and 54 changes as a starting point.

(3-4. Cushioning Sheet 60 of Fourth Example)

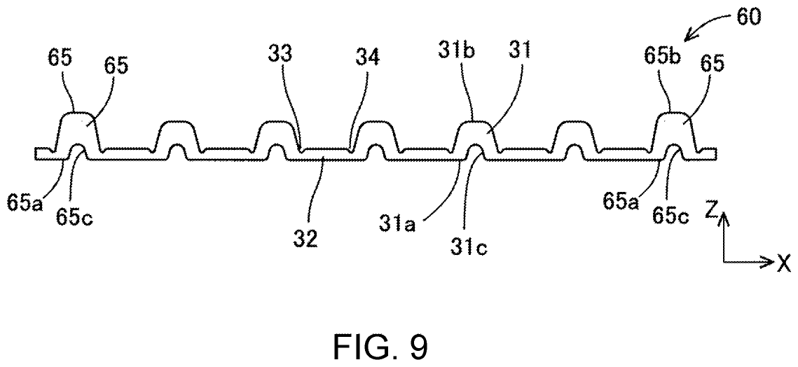

A cushioning sheet 60 of a fourth example will be described with reference to FIG. 9. In the cushioning sheet 60 of the fourth example, the same components as those of the cushioning sheet 30 of the first example are designated by the same reference numerals and the description thereof will be omitted. As shown in FIG. 9, the cushioning sheet 60 includes a plurality of main support parts 31, a plurality of connection parts 32, and a pair of outer support parts 65 and 65. The main support part 31 and the connection part 32 have the same configuration as the main support part 31 and the connection part 32 of the first example.

The pair of outer support parts 65 and 65 is located on both outer sides of the plurality of main support parts 31 in the parallel arrangement direction. The outer support parts 65 are connected to the main support parts 31 at both ends through the connection part 32. Further, the outer support part 65 extends in the reference direction (Y direction). That is, the outer support part 65 extends in a direction parallel to the main support part 31. Similarly to the main support part 31, each of the outer support parts 65 and 65 is formed of one elongated body extending over the entire length in the reference direction (Y direction) of the cushioning sheet 60.

The outer support part 65 is formed in a tapered shape (for example, a trapezoid) similar to the main support part 31 in a cross-section (cross-section parallel to the X-Z plane) orthogonal to the reference direction (Y direction). In this example, the outer support part 65 is formed in an isosceles trapezoid, but may be formed in an isosceles trapezoid.

Specifically, the outer support part 65 is formed in a tapered shape including a wide surface 65a and a narrow surface 65b facing back-to-back. A part of the wide surface 65a contacts the first member A and the narrow surface 65b contacts the second member B. The height of the outer support part 65, that is, the distance between the wide surface 65a and the narrow surface 65b is formed to be higher than the height of the main support part 31. That is, the outer support part 65 is higher than the protrusion height of the main support part 31.

Further, the outer support part 65 includes a recess 65c similarly to the main support part 31. The recess 65c of the outer support part 65 may have the same shape as that of the main recess 31c of the main support part 31 or may have a shape different from that of the main recess 31c.

For example, when the battery module 1 shown in FIGS. 1 and 2 is the application target of the cushioning sheet 60, the central part of the cushioning sheet 60 in the sheet width direction (the central part in the left and right direction of FIG. 9) may have a large deformation amount in the thickness direction and both end parts of the cushioning sheet 60 in the sheet width direction (both end parts in the left and right direction of FIG. 9) may have a small deformation amount in the thickness direction in view of the expanding deformation shape of the battery module 1.

Therefore, the outer support part 65 is located at both ends in which the expanding deformation amount is small and the main support part 31 is located at the central part in which the expanding deformation amount is large. Thus, the cushioning sheet 60 can exhibit an appropriate support force in response to the expanding deformation amount of the battery module 1.

(3-5. Cushioning Sheet 70 of Fifth Example)

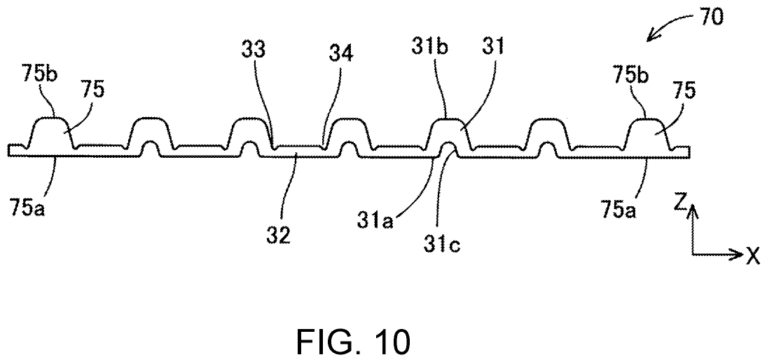

A cushioning sheet 70 of a fifth example will be described with reference to FIG. 10. In the cushioning sheet 70 of the fifth example, the same components as those of the cushioning sheet 30 of the first example are designated by the same reference numerals and the description thereof will be omitted. As shown in FIG. 10, the cushioning sheet 70 includes a plurality of main support parts 31, a plurality of connection parts 32, and a pair of outer support parts 75 and 75. The main support part 31 and the connection part 32 have the same configuration as the main support part 31 and the connection part 32 of the first example.

The pair of outer support parts 75 and 75 is located on both outer sides of the plurality of main support parts 31 in the parallel arrangement direction. The outer support parts 75 are connected to the main support parts 31 at both ends through the connection part 32. Further, the outer support part 75 extends in the reference direction (Y direction). That is, the outer support part 75 extends in a direction parallel to the main support part 31. Similarly to the main support part 31, each of the outer support parts 75 and 75 is formed of one elongated body extending over the entire length in the reference direction (Y direction) of the cushioning sheet 70.

The outer support part 75 is formed in a tapered shape (for example, a trapezoid) similar to the main support part 31 in a cross-section (cross-section parallel to the X-Z plane) orthogonal to the reference direction (Y direction). In this example, the outer support part 75 is formed in an isosceles trapezoid, but may be formed in an isosceles trapezoid.

Specifically, the outer support part 75 is formed in a tapered shape including a wide surface 75a and a narrow surface 75b facing back-to-back. However, a recess is not provided in the wide surface 75a and the narrow surface 75b of the outer support part 75. Then, the entire surface of the wide surface 75a contacts the first member A and the entire surface of the narrow surface 75b contacts the second member B. The height of the outer support part 75, that is, the distance between the wide surface 75a and the narrow surface 75b is the same as the height of the main support part 31.

For example, when the battery module 1 shown in FIGS. 1 and 2 is the application target of the cushioning sheet 70, the central part of the cushioning sheet 70 in the sheet width direction (the central part in the left and right direction of FIG. 10) may have a large deformation amount in the thickness direction and both end parts of the cushioning sheet 70 in the sheet width direction (both end parts in the left and right direction of FIG. 10) may have a small deformation amount in the thickness direction in view of the expanding deformation shape of the battery module 1.

Therefore, the outer support part 75 is located at both ends in which the expanding deformation amount is small and the main support part 31 is located at the central part in which the expanding deformation amount is large. The allowed deformation amount is small by the amount that the outer support part 75 does not include a main recess 31c compared to the main support part 31. Thus, the cushioning sheet 70 can exhibit an appropriate support force in response to the expanding deformation amount of the battery module 1.

(3-6. Cushioning Sheet 80 of Sixth Example)

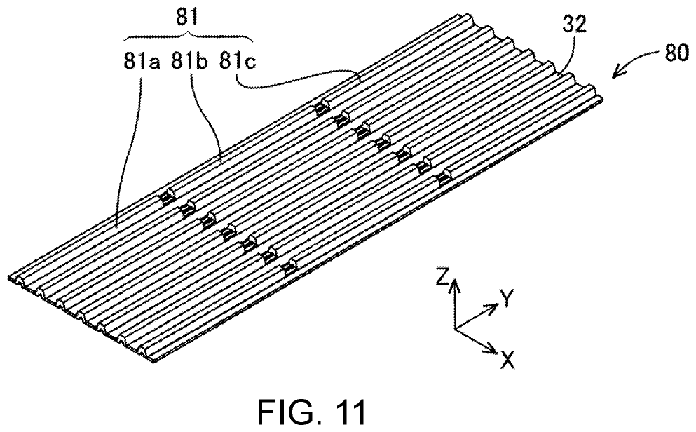

A cushioning sheet 80 of a sixth example will be described with reference to FIG. 11. In the cushioning sheet 80 of the sixth example, the same components as those of the cushioning sheet 30 of the first example are designated by the same reference numerals and the description thereof will be omitted. As shown in FIG. 11, the cushioning sheet 80 includes a plurality of main support parts 81 and a plurality of connection parts 32.

In the cushioning sheet 30 of the first example, each of the main support parts 31 is formed of one elongated body extending over the entire length in the reference direction (Y direction) of the cushioning sheet 30. On the other hand, in the cushioning sheet 80 of the sixth example, each of the main support parts 81 is formed of a plurality of elongated bodies 81a, 81b, and 81c arranged at predetermined intervals in the reference direction (Y direction).

The main support part 81 is formed in a tapered shape (for example, a trapezoid) similar to the main support part 31 of the first example in the cross-section orthogonal to the reference direction (Y direction) (the cross-section parallel to the X-Z plane). That is, the main support part 81 includes a wide surface 31a and a narrow surface 31b and is provided with a main recess 31c.

Further, the main recess 31c and sub-recesses 33 and 34 are formed over the entire length of the cushioning sheet 80. That is, the main recess 31c and the sub-recesses 33 and 34 are also formed in a part in which an elongated body constituting the main support part 81 does not exist. However, the main recess 31c and the sub-recesses 33 and 34 may be formed only in a part in which the elongated body constituting the main support part 81 exists.

(3-7. Cushioning Sheet 90 of Seventh Example)

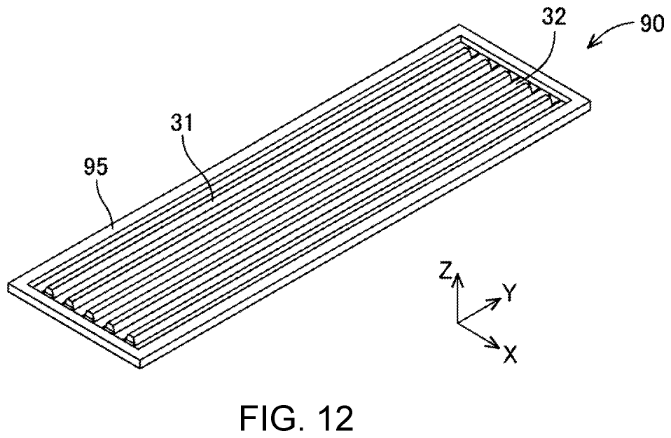

A cushioning sheet 90 of a seventh example will be described with reference to FIG. 12. In the cushioning sheet 90 of the seventh example, the same components as those of the cushioning sheet 30 of the first example are designated by the same reference numerals and the description thereof will be omitted. As shown in FIG. 12, the cushioning sheet 90 includes a plurality of main support parts 31, a plurality of connection parts 32, and an outer frame part 95. The main support part 31 and the connection part 32 have the same configuration as the main support part 31 and the connection part 32 of the first example.

The outer frame part 95 is formed around the entire outer peripheral edge of the cushioning sheet 90, and is filled with an elastic material. The cross-section orthogonal to the extension direction of the outer frame part 95 can be any shape such as a rectangle, a trapezoid, or a chevron. The outer frame part 95 exhibits the same function as that of the outer support part 75 of the cushioning sheet 70 of the fifth example.

(4. Cushioning Sheet Manufacturing Method)

(4-1. Example of Cushioning Sheet Manufacturing Method)

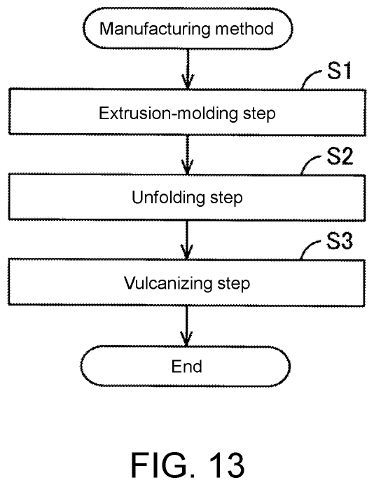

An example of a cushioning sheet manufacturing method will be described with reference to FIGS. 13 to 15. The manufacturing method described below is applicable to the cushioning sheets 30, 40, 50, 60, and 70 of the first to fifth examples described above. Hereinafter, the cushioning sheet 30 of the first example will be given as an example.

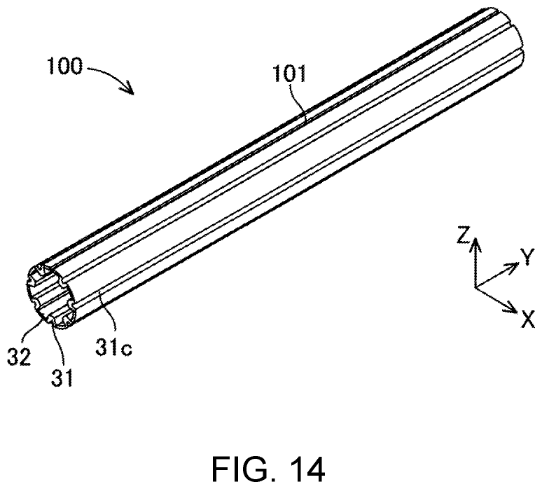

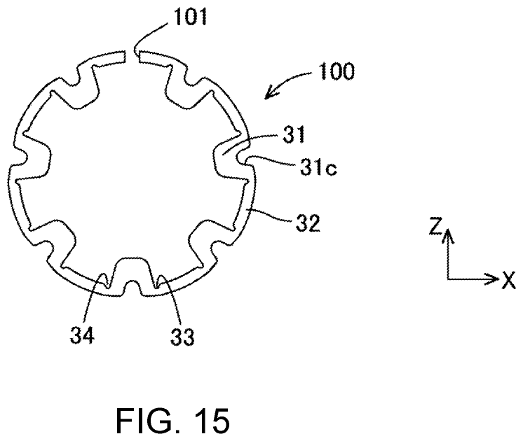

First, a premolded product 100 shown in FIGS. 14 and 15 is molded by an extruder (not shown) using an elastic material whose base material is resin or elastomer (step S1 in FIG. 13: extrusion-molding step). The premolded product 100 forms a C-shaped or U-shaped cross-section orthogonal to the extrusion direction by matching the extrusion direction with the reference direction (Y direction). FIGS. 14 and 15 show a case of a C-shaped cross-section. That is, the premolded product 100 has a slit 101 which is a cut portion formed in a C shape or a U shape over the entire length.

Here, in this example, as shown in FIGS. 14 and 15, the premolded product 100 is extrusion-molded into a C shape or a U shape so that the main recess 31c is located radially outside. That is, the protrusion direction of the main support part 31 faces inward in the radial direction. In this case, in the cushioning sheets 30, 40, 60, and 70 of the first example, the second example, the fourth example, and the fifth example, the premolded product 100 is extrusion-molded into a C shape or a U shape so that the sub-recesses 33 and 34 are located radially inside. Further, in the cushioning sheet 50 of the third example, the premolded product 100 is extrusion-molded into a C shape or a U shape so that the sub-recesses 53 and 54 are located radially outside.

In addition to the above, the premolded product 100 may be extrusion-molded in a C shape or a U shape so that the main recess 31c is located radially inside. That is, the protrusion direction of the main support part 31 faces the outside in the radial direction. In this case, in the cushioning sheets 30, 40, 60, and 70 of the first example, the second example, the fourth example, and the fifth example, the premolded product 100 is extrusion-molded into a C shape or a U shape so that the sub-recesses 33 and 34 are located radially outside. Further, in the cushioning sheet 50 of the third example, the premolded product 100 is extrusion-molded into a C shape or a U shape so that the sub-recesses 53 and 54 are located radially inside.

Next, the premolded product 100 subjected to extrusion-molding is expanded so that C-shaped or U-shaped slits are located at both ends (step S2 in FIG. 13: unfolding step). At this time, the premolded product 100 can be widened from the main recess 31c and the sub-recesses 33, 34, 53, and 54. Thus, the premolded product can be easily widened. Next, the cushioning sheets 30, 40, 50, 60, and 70 are manufactured by vulcanizing the premolded product 100 in the widened state by the vulcanization equipment (step S3 in FIG. 13: vulcanizing step).

If the cushioning sheet 30 or the like having a flat plate shape is extrusion-molded by an extruder, the maximum width of the mold of the extruder needs to be the width or more of the cushioning sheet 30 or the like. Thus, when the width of the cushioning sheet 30 or the like increases, the mold of the extruder increases in size. However, in the above-described manufacturing method, the cushioning sheet 30 or the like is manufactured by extrusion-molding a cross-section orthogonal to the extrusion direction into a C shape or a U shape by the extruder and widening the cross-section so that C-shaped or U-shaped slits are located at both ends. Thus, the mold of the extruder can be made smaller than the width of the cushioning sheet 30 or the like.

Further, when widening the premolded product 100 having a C-shaped or U-shaped cross-section subjected extrusion-molding, the main recess 31c and the sub-recesses 33, 34, 53, and 54 are used as starting points. Therefore, the cushioning sheet 30 or the like can be formed in a desired shape even after the cushioning sheet is extrusion-molded into a C shape or a U shape by an extruder and then is widened.

Here, when the protrusion direction of the main support part 31 is inward in the radial direction of the premolded product 100, the protruding portion of the main support part 31 can be accommodated in a region surrounded by the connection part 32 and the portion on the wide surface 31a side of the main support part 31. Therefore, the width of the premolded product 100 can be made smaller.

Further, in the cushioning sheets 30, 40, 60, and 70, the premolded product 100 is formed such that the sub-recesses 33 and 34 open inward in the radial direction when the main recess 31c opens outward in the radial direction. In this case, the premolded product 100 is widened by expanding and deforming the sub-recesses 33 and 34. That is, the sub-recesses 33 and 34 easily act as the starting points for expansion and deformation. As a result, the premolded product 100 can be easily widened from the C shape or the U shape.

Further, in the cushioning sheet 50, the premolded product 100 may be formed such that the main recess 31c and the sub-recesses 53 and 54 open inward in the radial direction. In this case, the premolded product 100 is widened by expanding and deforming the main recess 31c and the sub-recesses 53 and 54. That is, the main recess 31c and the sub-recesses 53 and 54 easily act as starting points for expansion and deformation. As a result, the premolded product 100 can be easily widened from the C shape or the U shape.

(4-2. Other Manufacturing Methods)

The cushioning sheets 80 and 90 of the sixth and seventh examples are not easily manufactured by extrusion-molding since the cross-section orthogonal to the reference direction (the cross-section parallel to the X-Z plane) is not the same over the entire length of the reference direction (Y direction). Therefore, the cushioning sheets 80 and 90 may be manufactured by injection-molding. The other cushioning sheets 30 to 70 may also be manufactured by injection-molding.

What is claimed is:

1. A cushioning sheet, formed of an elastic material and sandwiched between a first member and a second member facing each other, the cushioning sheet comprising:
a plurality of main support parts, extending in a predetermined reference direction in a plane direction of the cushioning sheet, formed in a tapered shape having a wide surface and a narrow surface facing back-to-back in a cross-section orthogonal to the reference direction, and disposed with at least a part of the wide surface in contact with the first member and the narrow surface in contact with the second member; and
a connection part having a band shape, connecting inclined side surfaces of the tapered shape on the wide surface side in adjacent ones of the plurality of main support parts, and disposed in contact with the first member and at a distance from the second member,
wherein, in a central part of the tapered shape in a width direction in the wide surface of the plurality of main support parts, a main recess is formed extending in the reference direction and opening toward the first member, and
wherein, in a boundary portion between the plurality of main support parts and the connection part, a sub-recess is formed extending in the reference direction, opening toward at least one of the first member and the second member, and having a smaller opening width than the main recess.

2. The cushioning sheet according to claim 1,
wherein the sub-recess has a shallower depth from an opening than the main recess.

3. The cushioning sheet according to claim 1,
wherein when a separation distance between the first member and the second member is reduced, the plurality of main support parts are compressed and deformed, and is deformed so that a width of the wide surface is expanded in the width direction, and
wherein, as the plurality of main support parts are deformed, a cross-section in a band width direction of the connection part is curved and deformed in a convex shape toward the second member with the sub-recess as a starting point.

4. The cushioning sheet according to claim 3,
wherein the sub-recess opens toward the first member, and
wherein the connection part is curved and deformed in the convex shape with deformation in which the opening width of the sub-recess changes as a starting point.

5. The cushioning sheet according to claim 3,
wherein the sub-recess opens toward the second member, and
wherein the connection part is curved and deformed in the convex shape with deformation in which the opening width of the sub-recess changes as a starting point.

6. The cushioning sheet according to claim 3,
wherein the connection part presses the second member while being curved and deformed in the convex shape.

7. The cushioning sheet according to claim 6,
wherein the connection part comprises, on a surface on the second member side, a small protrusion smaller than a protrusion height of the plurality of main support parts, and
wherein the small protrusion presses the second member while the connection part is curved and deformed in the convex shape.

8. The cushioning sheet according to claim 6,
wherein a surface of the connection part on the second member side is formed in a planar shape in a non-deformation state, and
wherein the surface of the connection part on the second member side presses the second member while the connection part is curved and deformed in the convex shape.

9. The cushioning sheet according to claim 1, further comprising:
an outer support part, located on both outer sides of the plurality of main support parts, connected to the plurality of main support parts at both ends through the connection part, extending in the reference direction, formed in a tapered shape having a wide surface and a narrow surface facing back-to-back in the cross-section orthogonal to the reference direction, disposed with at least a part of the wide surface in contact with the first member and the narrow surface in contact with the second member, and higher than a protrusion height of the plurality of main support parts.

10. The cushioning sheet according to claim 1, further comprising:
an outer support part, located on both outer sides of the plurality of main support parts, connected to the plurality of main support parts at both ends through the connection part, extending in the reference direction, formed in a tapered shape having a wide surface and a narrow surface facing back-to-back in the cross-section orthogonal to the reference direction, and disposed with an entire surface of the wide surface in contact with the first member and an entire surface of the narrow surface in contact with the second member.

11. The cushioning sheet according to claim 1,
wherein each of the plurality of main support parts is formed of one elongated body extending in the reference direction.

12. The cushioning sheet according to claim 1,
wherein each of the plurality of main support parts is formed of a plurality of elongated bodies arranged at predetermined intervals in the reference direction.

13. The cushioning sheet according to claim 1,
wherein the cushioning sheet is applied to a battery module comprising a laminated body of a plurality of battery cells and a restraining member restraining the laminated body from both ends of the laminated body in a lamination direction, and
wherein the first member and the second member are the battery cell and the restraining member facing each other or two battery cells facing each other.

14. The cushioning sheet according to claim 3,
wherein the cushioning sheet is applied to a battery module comprising a laminated body of a plurality of battery cells and a restraining member restraining the laminated body from both ends of the laminated body in a lamination direction,
wherein the first member and the second member are the battery cell and the restraining member facing each other or two battery cells facing each other, and
wherein when the plurality of battery cells are fully charged, area of a space formed by the connection part that is curved and deformed and the first member is greater than area of the main recess in the cross-section orthogonal to the reference direction.

15. A method for manufacturing a cushioning sheet, manufacturing the cushioning sheet according to claim 1, the method comprising:
extrusion-molding an elastic material whose base material is resin or elastomer by an extruder in which an extrusion direction matches the reference direction and a cross-section orthogonal to the extrusion direction has a C shape or a U shape; and
widening with the main recess and the sub-recess as a starting point so that a slit having the C shape or the U shape that is extrusion-molded is located at both ends.

16. The method for manufacturing a cushioning sheet according to claim 15,
wherein the extrusion-molding into the C shape or the U shape is performed so that the main recess is located radially outside.

17. The method for manufacturing a cushioning sheet according to claim 16,
wherein the sub-recess opens toward the second member, and
wherein the extrusion-molding into the C shape or the U shape is performed so that the main recess is located radially outside and the sub-recess is located radially inside.

18. The method for manufacturing a cushioning sheet according to claim 15,
wherein the sub-recess opens toward the first member, and
wherein the extrusion-molding into the C shape or the U shape is performed so that the main recess is located radially inside and the sub-recess is located radially inside.
